(19) United States
(12) Patent Application Publication
(10) Pub. No.: US 2014/0154613 A1
(43) Pub. Date: Jun. 5, 2014

(54) AIR ELECTRODE CATALYST MATERIAL, SOLID OXIDE FUEL CELL SYSTEM, AND METHOD OF MANUFACTURING THE AIR ELECTRODE CATALYST MATERIAL

(71) Applicants: THE UNIVERSITY OF TOKYO, BUNKYO-KU (JP); JX NIPPON OIL & ENERGY CORPORATION, CHIYODA-KU (JP)

(72) Inventors: YASUSHI SATO, CHIYODA-KU (JP); TAKAO KUDO, CHIYODA-KU (JP); KOICHI YAMAMURO, CHIYODA-KU (JP); SHU YAMAGUCHI, BUNKYO-KU (JP); SHOGO MIYOSHI, BUNKYO-KU (JP); AYANO TAKESHITA, BUNKYO-KU (JP)

(21) Appl. No.: 13/906,379

(22) Filed: May 31, 2013

(30) Foreign Application Priority Data
Dec. 3, 2012 (JP) 2012-264301

(51) Int. Cl. H01M 4/90; H01M 4/88

(52) U.S. Cl. CPC H01M 4/9033; H01M 4/8867; H01M 4/8871
USPC 429/527; 429/528; 502/302; 502/303; 502/324; 502/328; 502/5

(57) ABSTRACT

An air electrode catalyst material according to an embodiment of the present invention is used in solid oxide fuel cells and includes a perovskite oxide represented by a general formula (1): AₓB_{y}O₃₋₆. A ratio x/y of the A to the B is 1.05≦x/y≦1.5, and a peak derived from a perovskite structure A₁B₁O_{3-δ} is shown in a chart obtained by an X-ray diffraction measurement, and in Raman spectra, an area of absorption peak existing between 560 cm⁻¹ and 620 cm⁻¹ (inclusive) is larger than that between 380 cm⁻¹ and 440 cm⁻¹ (inclusive).

### BACKGROUND OF THE INVENTION

1. Field of the Invention

The present invention relates to an air electrode catalyst material, a solid oxide fuel cell system, and a method of manufacturing air electrode catalyst material.

(2) Description of the Related Art

In general, the power conversion efficiencies of solid oxide fuel cells (SOFCs) are higher than those of polymer electrolyte fuel cells (PEFCs). In addition, not only hydrogen, but also carbon monoxide and unreformed methane, etc., which are obtained as by-products when raw materials and fuels, such as hydrocarbon, alcohol, and dimethyl ether (DME), are reformed, can be used as a fuel for the power generation. Accordingly, it is known that an SOFC does not require a reactor for removing CO, etc., in a reforming step and hence has the merit that it can be miniaturized.

On the other hand, the operating temperatures of SOFCs are mostly as high as 700° C. or higher. Even in intermediate temperature SOFCs (IT-SOFCs) that are being developed in recent years, a system that can be used as a device with practical use, which can be operated at a temperature lower than 600° C., has not been reported yet, although a system that can be operated at a lower temperature has been reported in a research phase.

One of the reasons why the operating temperature of an SOFC should be lowered is to reduce the durability required of a material used in the SOFC. Examples of the causes by which a decrease in voltage or short-term breakdown occurs in current SOFCs include both a change in the properties of the material, accompanying an interlayer element migration reaction or a surface oxidation reaction occurring because a cell or a cell stack structure is used at a high temperature, and a decrease in voltage occurring due to the formation of a high-resistance layer. In addition to that, thermal stress fracture, occurring due to repeated changes in temperature between a high temperature at which an SOFC is being operated and a temperature near to room temperature while the SOFC is being stopped, is also included. These are most of the causes for decreases in voltage or short-term breakdown in SOFCs. Accordingly, when the operating temperature of SOFCs can be lowered, it becomes possible to alleviate the causes for these degradation and breakdown.

Another reason why the operating temperature of an SOFC should be lowered is to adopt a metallic material, the use of which has been difficult before, or to increase the flexibility in selecting ceramic materials and glass materials, by lowering the operating temperature thereof. Thereby, the cost performance of an SOFC can be improved. In addition, still another reason why the operating temperature of an SOFC should be lowered is to reduce a burden for monitoring the factors to which particular attention should be paid while the SOFC is being operated at a high temperature, such as a coefficient of thermal expansion and heat deformation. Thereby, it can be expected to drastically reduce the manufacturing cost and quality control items for the manufacture of a cell or a stack.

From these reasons, research and development of IT-SOFCs for practical use, in particular, research of solid oxide electrolytes and air electrode materials, which are dominant factors for determining the performance of an IT-SOFC under a low temperature condition, is being actively conducted. Of the two materials, with respect to the solid oxide electrolytes, a gallate oxygen ion conducting oxide has been reported recently (see, for example, Non-Patent Document 1), and various proton conducting oxides have been reported recently (see, for example, Non-Patent Document 2). Of them, the gallate system is already being developed as a cell stack with practical use (see, for example, Patent Document 1).

### Patent Document

[Patent Document 1] Japanese Patent Publication No. 4953152

### Non-Patent Documents

[Non-Patent Document 1] T. Ishihara et al., Journal of the European Ceramic Society 24 (2004) 1329-1335

[Non-Patent Document 2] M. Amsif et al./Journal of Power Sources 196 (2011) 3461-3469

[Non-Patent Document 3] Koichi Eguchi, Solid Oxide Fuel Cell: Development of SOFC, CMC Publishing Co., Ltd., First Printing, p 168-171, 2005

[Non-Patent Document 4] T. Ishihara et al., Abstract #1924, Honolulu PRiME 2012, c 2012 The Electrochemical Society

[Non-Patent Document 5] M. Sase et al., Solid State Ionics 178 (2008) 1843-1852

On the other hand, the air electrode material is investigated such that: the activity thereof at a low temperature is improved by an oxide composition (see, for example, Non-Patent Document 3); and the activity thereof is improved by an electrode structure, mainly by a steric structure of a reactive site (see, for example, Non-Patent Document 4). In both the investigations, certain successful results have been obtained in research stages, respectively; however, there are still room for further investigation from the viewpoint of establishment of a system with practical use.

### SUMMARY OF THE INVENTION

The present invention has been made in view of these situations, and a purpose of the invention is to provide a technique in which the operating temperature of an SOFC can be lowered.

An embodiment of the present invention is an air electrode catalyst material to be used in SOFCs. The air electrode catalyst material is one to be used in SOFCs and comprises a perovskite oxide represented by a general formula (1): AₓB_{y}O_{3-δ} (wherein, A contains at least one element selected from the group consisting of Mg, Ca, Sr, Ba, Sc, Y, and lanthanoid element; B contains at least one element selected from the group consisting of Mn, Fe, Co, and Ni; and δ indicates an amount of oxygen deficiency or oxygen excess for matching the valence number of the perovskite oxide), in which a ratio x/y of the A to the B is 1.05≦x/y≦1.5, and in which a peak derived from a perovskite structure A₁B₁O_{3-δ} is shown in a chart obtained by an X-ray diffraction measurement, and in Raman spectra, an area of absorption peak existing between 560 cm⁻¹ and 620 cm⁻¹ (inclusive) is larger than that between 380 cm⁻¹ and 440 cm⁻¹ (inclusive).

Another embodiment of the present invention is an SOFC system. The SOFC system comprises: an air electrode containing the air electrode catalyst material according to the aforementioned embodiment; a fuel electrode; and an electrolyte body arranged between the air electrode and the fuel electrode.

Still another embodiment of the present invention is a method of manufacturing an air electrode catalyst material to be used in SOFCs. The method of manufacturing an air electrode catalyst material comprises: arranging a first electrode material and a second electrode material so as to be adjacent to each other, the first electrode material being represented by a general formula (1): AₓB_{y}O_{3-δ} (wherein, A contains at least one element selected from the group consisting of Mg, Ca, Sr, Ba, Sc, Y, and lanthanoid element; B contains at least one element selected from the group consisting of Mn, Fe, Co, and Ni; and δ indicates an amount of oxygen deficiency or oxygen excess for matching the valence number of the perovskite oxide), in which a ratio x/y of the A to the B is 0.80≦x/y<1.25, and the second electrode material having a ratio x/y of the A to the B in the general formula (1) of 1.5≦x/y≦2.5; and calcining the first electrode material and the second electrode material, which are arranged to be adjacent to each other, at a temperature higher than or equal to 450° C.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a transmission electron microscope image of a section of a calcined laminated body obtained by calcining a laminated body made of an electrolyte layer/a first electrode material layer/a second electrode material layer;

FIG. 2 is a graph showing XRD measurement results of an uncalcined laminated body and the calcined laminated body;

FIG. 3(A) is a graph showing Raman spectra measurement results of the uncalcined laminated body and the calcined laminated body;

FIG. 3(B) is a graph showing results in which peak area ratios are calculated by fitting the Raman spectra measurement results of the uncalcined laminated body and the calcined laminated body with the use of a Gaussian function;

FIGS. 4(A) to 4(C) are schematic views illustrating a cell structure for evaluating the performance of the calcined laminated body containing an air electrode catalyst material according to an embodiment, when the laminated body is used as an air electrode;

FIG. 5(A) is a graph obtained by plotting, on a complex plane, impedance values measured for the calcined laminated body, which was calcined at a sample temperature of 600° C.; and

FIG. 5(B) is a graph showing temperature dependence of the electrical conductivity in the calcined laminated body.

### DETAILED DESCRIPTION OF THE INVENTION

The invention will now be described by reference to the preferred embodiments. This does not intend to limit the scope of the present invention, but to exemplify the invention.

Hereinafter, embodiments of the present invention will de described with reference to the accompanying drawings. The same or like components illustrated in each drawing are denoted by like reference numerals, and the duplicative descriptions will be appropriately omitted.

Before the description of the embodiments, a knowledge obtained by the present inventors will be first described. The inventors have focused attention on a phenomenon in which, in both a lanthanum cobaltite oxide (La_{(1-z)x}Sr_{zx}Co_{y}O_{3-δ}, hereinafter, this oxide will be appropriately referred to as LSC), which has, among the materials currently used as air electrode materials for SOFCs, a high activity at a relatively low temperature, and a compound similar thereto, the activity of an air electrode reaction is specifically improved near to an interface between crystal structures different from each other (see, for example, Non-Patent Document 5).

In Non-Patent Document 5, it has been confirmed from measurement results using a secondary ion mass spectrometer that, in small part of an area where both 113 structure and 214 structure, which are two crystal structures of LSC and different from each other, contact a gas-phase interface, the activity of an oxygen exchange reaction, which is larger than that in an area where normal 113 structure is only present by a few orders of magnitude, is exhibited. Herein, the 113 structure means a structure represented by a general formula of ABO_{3-δ}, and the 214 structure means a structure represented by a general formula of A₂BO_{4-δ}. The present inventors have intensively studied in order: to improve the activity of an air electrode at a low temperature by using the aforementioned principle in which a reaction activity is locally improved; to make it possible to industrially manufacture a site where the a reaction activity is improved with good reproducibility; and to make an electrode structure having a certain area to exert performance at a low temperature, etc., thereby inventing an air electrode catalyst material and a manufacturing method thereof according to the present embodiments. Hereinafter, the air electrode catalyst material and the manufacturing method thereof according to the embodiments will be described.

The present inventors have determined a cause by which the activity of an air electrode reaction is improved in small part of an area where both the aforementioned LSC 113 structure and LSC 214 structure contact a gas-phase interface. As a result, the inventors have found that: a major factor, by which an interface electrical conductivity σ_{E}, obtained by impedance analysis of an electrode, is drastically increased due to a surface oxygen exchange reaction, is generation of a new highly-active layer due to the heating of both the structures in a state where the structures contact each other on an interface, rather than due to an effect by the interface itself between the LSC 113 structure and LSC 214 structure, such as an electronic-state modulation effect or lattice stress between crystal interfaces.

As a result of analyzing this highly-active layer by various methods, it was known that the layer has a composition close to an LSC 214 phase, but a peak of the LSC 214 phase was not confirmed by X-ray diffraction (XRD), etc. Instead, a peak of an LSC 113 phase was confirmed. Further, it was found out from Raman spectra of the highly-active layer that an absorption peak, which was considered to be derived from the asymmetry of a crystal structure, was present between 560 cm⁻¹ and 620 cm⁻¹. That is, a single crystal layer, in which the symmetry of a crystal structure is disordered due to a solid phase reaction between the LSC 113 crystal phase and the LSC 214 crystal phase, can be generated by forming both the crystal phases so as to be adjacent to each other and by performing a heat treatment on them under suitable conditions, thereby allowing a highly-active layer to be industrially manufactured with good reproducibility.

### (Composition of Air Electrode Catalyst Material)

An air electrode catalyst material according to the present embodiment is a catalyst material to be used in SOFCs, and contains a perovskite oxide represented by a general formula (1): AₓB_{y}O_{3-δ} (hereinafter, this perovskite oxide is appropriately referred to as a highly-active compound). In the general formula (1), the A contains at least one element selected from the group consisting of Mg, Ca, Sr, Ba, Sc, Y, and lanthanoid element (Ln). The B contains at least one element selected from the group consisting of Mn, Fe, Co, and Ni. The δ indicates an amount of oxygen deficiency or oxygen excess for matching the valence number of the perovskite oxide. The range of δ is, for example, −0.3<δ<0.5.

In this highly-active compound, a ratio x/y of the A to the B in the general formula (1) is 1.05≦x/y≦1.5. In addition, in the air electrode catalyst material according to the present embodiment, a peak derived from a perovskite structure A₁B₁O_{3-δ} (later-described 113 phase) is shown in a chart obtained by an X-ray diffraction measurement. In addition, in Raman spectra, an area of absorption peak existing between 560 cm⁻¹ and 620 cm⁻¹ (inclusive) is larger than that between 380 cm⁻¹ and 440 cm⁻¹ (inclusive).

In addition, in the air electrode catalyst material according to the present embodiment, it is preferable that the highly-active compound contains La as the A in the general formula (1) and Co as the B. In addition, it is preferable that the highly-active compound has a structure (LSC) represented by a general formula (2): La_{(1-z)x}Sr_{zx}Co_{y}O_{3-δ}. In the LSC, the A in the general formula (1) means La, part of which has been substituted by Sr. In this case, it is preferable that a substitution rate z at which the La in the A has been substituted by the Sr, in other words, a value of the z in the general formula (2) is 0.05≦z≦0.75. That is, it is preferable that, assuming that the total number of moles of the La occupying the A site is 100%, the substitution rate (solid solution ratio) of the Sr in the A site is 5% or more to 75% or less.

The activity of the Sr is enhanced by increasing the substitution rate of the Sr, thereby allowing the activity of an air electrode to be enhanced. In addition, by making the z to be 0.05 or more, an amount of oxygen deficiency in a perovskite lattice can be increased, thereby allowing the activity of an air electrode to be enhanced more surely. In addition, by making the z to be 0.75 or less, it can be prevented more surely that the perovskite crystal structure may become unstable and hence the durability, occurring when used at a high temperature and for a long period of time, may be deteriorated.

### (Method of Manufacturing Air Electrode Catalyst Material)

The air electrode catalyst material according to the present embodiment can be manufactured, for example, in the following way. That is, a method of manufacturing an air electrode catalyst material according to the present embodiment comprises: arranging, so as to be adjacent to each other, a first electrode material (hereinafter, the first electrode material is appropriately represented by a general formula (3): ABO_{3-δ} or A₁B₁O_{3-δ} and is referred to as 113 phase) and a second electrode material (hereinafter, the second electrode material is appropriately represented by a general formula (4): A₂BO_{4-δ} and is referred to as 214 phase); and calcining the first electrode material and the second electrode material that are arranged so as to be adjacent to each other. Hereinafter, the compositions of the respective electrode materials, a method of arranging the respective electrode materials so as to be adjacent to each other, a method of calcining them, and identification and performance evaluation of the highly-active layer will be described in detail.

### (First Electrode Material ABO_{3-δ}: 113 Phase)

The 113 phase contains at least a perovskite oxide having a ratio x/y of the A to the B in the general formula (1) of 0.80≦x/y<1.25. Similarly in the highly-active compound, the A contains one or more elements selected from the group consisting of Mg, Ca, Sr, Ba, Sc, Y, and Ln. The B contains one or more elements selected from the group consisting of Mn, Fe, Co, and Ni. The δ indicates an amount of oxygen deficiency or oxygen excess for matching the valence number of the compound, and δ is −0.3<δ<0.5.

By making the ratio x/y to be 0.80 or more, it can be avoided more surely that the formation of the highly-active layer may become difficult. That is, it can be avoided more surely that: an amount of B sites in a perovskite structure may become excessive, and hence a B site element (e.g., Co) may be likely to be liberated as an independent oxide (Co₃O₄, etc.), so that an A site element in a layer is extracted when a solid phase reaction between the layer and an adjacent layer occurs; and as a result, the composition of the perovskite oxide may deviate from a composition range in which the highly-active layer is generated. In addition, by making be the ratio x/y to be 1.25 or less, it can be avoided more surely that the formation of the highly-active layer may become difficult. That is, it can be avoided more surely that: an amount of A sites in a perovskite structure may become excessive, and hence an oxide of an A site element, in particular, an oxide, such as SrO, BaO, or the like, when an alkali earth metal oxide is doped into the A site element, may be likely to be liberated; and as a result, the formation of the highly-active layer may become difficult.

It is preferable that, similarly in the highly-active compound, the perovskite oxide contained in the 113 phase contains La as the A in the general formula (1) and Co as the B, and further preferable that the perovskite oxide is LSC. When it is LSC, it is preferable that a substitution rate z at which La in the A has been substituted by Sr is 0.05≦z≦0.75. The reason why the z is set to be 0.05≦z≦0.75 is as described above.

A CVD process, etc., can be adopted, as a gas-phase process, for synthesizing a composite oxide, such as LSC. In addition, precipitation processes represented by a coprecipitation process, a homogeneous precipitation process, a hydrolysis process, and a citrate process, a hydrothermal crystallization process, a micro-emulsion process, and a solvent evaporation process, etc., can be adopted as a liquid-phase process. In addition, a solid thermal pyrolysis process, a solid reaction process, and a hydrothermal crystallization process, etc., can be adopted as a solid phase process. It is preferable to adopt, among them, a commonly-known Pechini process in which: a precursor is formed by an esterification reaction between a chelate compound, made by a raw material metal ion and citric acid, and a polyalcohol, such as ethylene glycol; and then composite oxide particles are obtained by a heat treatment. After a composite oxide is synthesized, calcining in the air is performed at a temperature within a range of 800° C. to 1600° C., and preferably within a range of 1000° C. to 1400° C. A calcining time is within a range of 30 minutes to 36 hours, and preferably within a range of 1 hour to 12 hours.

The 113 phase usually has a high crystallinity. Accordingly, a corresponding peak can be easily confirmed by XRD in many cases. On the other hand, a 113 phase crystal having high symmetry is intrinsically Raman inactive; however, in the case of, for example, the LSC 113, minute peaks are mostly observed near to 180 cm⁻¹ and 400 cm⁻¹.

### (Second Electrode Material A₂BO_{4-δ}: 214 Phase)

The 214 phase contains at least a perovskite oxide having a ratio x/y of the A to the B in the general formula (1) of 1.5≦x/y≦2.5. Similarly in the highly-active compound, the A contains one or more elements selected from the group consisting of Mg, Ca, Sr, Ba, Sc, Y, and Ln. The B contains one or more elements selected from the group consisting of Mn, Fe, Co, and Ni. The δ indicates an amount of oxygen deficiency for matching the valence number of a compound, and is 0≦δ≦0.5.

By making the ratio x/y to be 1.5 or more, it can be avoided more surely that a solid phase reaction between the 214 phase and the 113 phase may not be carried out sufficiently, which possibly occurs because both the phases are close to each other in composition. In addition, by making the ratio x/y to be 2.5 or less, it can be avoided more surely that the formation of the highly-active layer may become difficult. That is, it can be avoided more surely that: an amount of A sites in a perovskite structure may become excessive, and hence an oxide of an A site element, in particular, an oxide, such as SrO, BaO, or the like, when an alkali earth metal oxide is doped into the A site element, may be likely to be liberated, so that a reaction between these oxides and the 113 phase is preferentially carried out during the solid phase reaction; and as a result, the formation of the highly-active layer, which is an original purpose, may become difficult.

It is preferable that, similarly in the highly-active compound, the perovskite oxide contained in the 214 phase contains La as the A in the general formula (1) and Co as the B, and further preferable that the perovskite oxide is LSC. When it is LSC, it is preferable that a substitution rate z at which the La in the A has been substituted by Sr is 0.05≦z≦0.75. The reason why the z is set to be 0.05≦z≦0.75 is as described above. In addition, it is preferable that the elements contained in the 214 phase are the same as those contained in the 113 phase, but they are not necessarily limited thereto.

A process similar to the aforementioned process for synthesizing the oxide in the 113 phase can be adopted for synthesizing an oxide that forms the 214 phase. Herein, there are sometimes the cases where the 214 phase is more resistant to being crystallized than the 113 phase, and hence crystal physical properties as the 214 phase cannot be necessarily exhibited. In this case, an average chemical composition may be within the range of the 214 phase, and the crystal structure of the 214 phase does not matter in this stage.

In the 214 phase, a corresponding peak is sometimes observed by XRD. In addition, a 214 phase crystal is Raman active, and in the case of, for example, LSC 214, a remarkable peak is frequently observed near to 700 cm⁻¹.

### (Arranging 113 Phase and 214 Phase so as to be Adjacent to Each Other)

When an air electrode of an SOFC is taken into consideration, in the arranging the first electrode material and the second electrode material so as to be adjacent to each other, it is preferable that both the two materials are arranged to be adjacent to each other by laminating a first electrode material layer and a second electrode material layer on a layer of the electrolyte body (hereinafter, this layer is appropriately referred to as an electrolyte layer). The two layers become an air electrode layer by being arranged so as to be adjacent to each other on the electrolyte layer and then by being calcined as described later.

An electrolyte body to be used is not particularly limited, but it is preferable that the electrolyte body is a solid oxide electrolyte body having a sufficient ion conductivity at a temperature lower than or equal to 600° C., the temperature being equivalent to a low temperature as an SOFC. Of such electrolyte bodies, YSZ (Y-Stabilized Zilconia), ScSZ (Sc-stabilized Zilconia), GDC (Gd-doped Ceria), LDC (La-doped Ceria), and LSGM (La—Sr—Ga—Mg composite oxide), etc., are preferably used as an oxygen ion conductor. In addition, BZY (Ba—Zr—Y composite oxide), BCY (Ba—Ce—Y composite oxide), BLC (Ba—La—Co composite oxide), etc., are preferably used as a proton conductor.

When a non-conductive layer, such as SrZrO₃ (SZ), is formed by a solid phase reaction between these ion conducting electrolyte bodies and the air electrode material, i.e., the first electrode material and/or the second electrode material, a reaction protective layer, as an intermediate layer, may be inserted to suppress a solid phase reaction occurring on the interface between the electrolyte body and the air electrode material. For example, when LSC is formed on YSZ, a solid phase reaction between the YSZ and the LSC can be prevented by inserting a thin layer of GDC in order to prevent the formation of SZ.

The thickness of the electrolyte layer (when the reaction protective layer is formed, a thickness including the reaction protective layer) cannot be uniformly defined because the thickness varies depending on the type of the electrolyte body to be used or a means for forming the electrolyte layer; however, the thickness is usually 50 nm to 200 micrometers, preferably 100 nm to 100 micrometers, and more preferably 500 nm to 75 micrometers. By making the thickness of the electrolyte layer to be 50 nm or more, it can be avoided more surely that cross leak of a gas may be caused due to a decrease in a barrier property for the gas between the fuel electrode and the air electrode. Also, it can be avoided more surely that a partial shorting may be caused due to a decrease in an electric insulating property. Also, it can be avoided more surely that a decrease in production yield may be caused because a pinhole, etc, is likely to be caused during the manufacture of a fuel cell. On the other hand, in an ion conductor having an identical volume conductivity, there is the fear that, as the thickness of the ion conductor is increased, a resistance per area is increased and ohmic loss (a direct-current resistance component mainly resulting from ion transport) is increased, thereby possibly causing a decrease in voltage. In regard to this, such a fear can be reduced by making the thickness of the electrolyte layer to be 200 micrometers or less.

It is preferable that the formation of the first electrode material layer on the electrolyte layer and/or the formation of the second electrode material layer on the first electrode material layer are/is performed by using a pulse laser process (PLD), a sputtering process, a chemical vapor deposition process (CVD), or the like. By using a thin film forming means, such as a pulse laser process, a sputtering process, a chemical vapor deposition process, or the like, as a means for arranging both the electrode materials so as to be adjacent to each other spatially, the air electrode catalyst material according to the present embodiment can be industrially formed with good reproducibility. As an example, various conditions under which the air electrode laminated body is formed by a sputtering process are shown in Table 1. In this example, the first electrode material (LSC 113 phase) and the second electrode material (LSC 214 phase), in each of which an LSC air electrode material prepared by a Pechini process is used, are used as targets, and GDC is used for a substrate.

```
TABLE 1
EXPERIMENT: PRODUCTION OF La—Sr—Co—O SPUTTERED
FILM
SPUTTERING TARGET:
    La_{1.2}Sr_{0.8}CoO₄, La_{0.6}Sr_{0.4}CoO₃, 0.5La_{0.6}Sr_{0.4}CoO₃ +
    0.5La_{1.2}Sr_{0.8}CoO₄
    POWDER SYNTHESIS BY CITRIC ACID METHOD
        NITRATE-MIXED WATER SOLUTION + CITRIC ACID→
        HEATING • DRYING • CALCINATION (950° C.)
    FINAL CALCINING (1250° C., 6 H)
SPUTTERING CONDITIONS
    SUBSTRATE: Ce_{0.9}Gd_{0.1}O_{1.95}(GDC)
            (USED FOR EVALUATION OF GENERATED
            PHASE & ELECTRODE PERFORMANCE)
                POWDERS MADE BY ANAN KASEI CO.,
                LTD. ARE FIRED AT 1600° C., THEN
                GROUND TO 1 μm
            MgO SINGLE CRYSTAL (USED FOR
            COMPOSITION ANALYSIS BY EDX)
            Si SUBSTRATE (USED FOR EVALUATION
            OF FILM THICKNESS BY
            CROSS-SECTIONAL SEM OBSERVATION)
    RF SPUTTERING APPARATUS SVC-700 RFII MADE BY
    SANYU ELECTRON CO., LTD.
    TEMPERATURE: NORMAL TEMPERATURE
    OUTPUT POWER: 150 W
    ATMOSPHERE: Ar
    PRESSURE IN CHAMBER: 2 Pa
    FILM-FORMING TIME: ≦44 h
ANALYSIS: XRD, SEM/EDX, Raman SPECTRA
```

The first electrode material layer and the second electrode material layer may be simultaneously deposited on the electrolyte layer, but it is more preferable to sequentially form both a base layer made by one of the above two layers and a surface layer made by the other of the two. When the first electrode material layer and the second electrode material are sequentially formed, the following two methods can be considered: a method in which the first electrode material layer is formed on the electrolyte layer and then the second electrode material layer is formed; and a method in which the second electrode material layer is formed on the electrolyte layer and then the first electrode material layer is formed. In particular, when an LSC material is used as the air electrode material, it is preferable that, because the bulk ion conductivity of a 113 phase electrode material itself is higher than that of a 214 phase electrode material itself, the first electrode material layer is first formed on the electrolyte layer and then the second electrode material layer (e.g., a thin layer of the second electrode material) is formed on the first electrode material layer.

When the first electrode material layer and the second electrode material layer are sequentially formed, a method can also be considered, in which, after the first layer is formed, a heat treatment is performed, and after the second layer is formed, a heat treatment is again performed. However, it is preferable that, after the second layer is formed, the two layers are collectively calcined without a heat treatment being performed after the first layer is formed, from the viewpoint that the solid phase reaction is more likely to be advanced. Also, there is a merit that a calcining process can be completed at one time.

The thickness of the first electrode material layer is 10 nm to 100 micrometers, preferably 20 nm to 50 micrometers, more preferably 30 nm to 10 micrometers, and most preferably 50 nm to 1 micrometer. By making the thickness of the first electrode material layer to be 10 nm or more, the first electrode material layer can be more easily obtained as a continuous layer (continuous film). Also, it can be avoided more surely that the highly-active layer may not be formed sufficiently in the solid phase reaction with the adjacent second electrode material layer. On the other hand, by making the thickness of the first electrode material layer to be 1 micrometer or less, it can be avoided more surely that an area that cannot be utilized for the electrode reaction may be caused in part of the layer due to the limit of the ion transport property of the bulk. Also, it can be avoided more surely that a decrease in voltage, occurring while a current is flowing, may become large due to an increase in an ohmic resistance resulting from electron conduction or hole conduction. However, when the air electrode material also serves as a collector material or an adhesive material with the collector material, the thickness thereof is not limited thereto.

The thickness of the second electrode material layer is 1 nm to 200 nm, preferably 5 nm to 100 nm, and more preferably 10 nm to 50 nm. By making the thickness of the second electrode material layer to be 1 nm or more, it can be avoided more surely that the highly-active layer may not be formed sufficiently in the solid phase reaction with the adjacent first electrode material layer. On the other hand, by making the thickness of the second electrode material layer to be 200 nm or less, it can be avoided more surely that a decrease in voltage may be caused due to an increase in the ion transport resistance of the bulk.

For example, when the second electrode material layer is laminated on the surface of the first electrode material layer, it is not needed that the surface of the first electrode material layer is a perfectly flat plane, and the surface may have a certain roughness factor (a value obtained by dividing an actual surface area by a projected area). Alternatively, a contact area of the first electrode material layer, where the first electrode material contacts the second electrode material layer to be laminated, may be increased by intentionally forming undulations or cyclic structures on the surface of the first electrode material layer. The cyclic structures can be formed, for example, by providing concavities and convexities in square patterns or by cyclically providing cone-shaped pits, etc.

### (Calcining)

A laminated body made of the electrolyte layer/the first electrode material layer/the second electrode material layer, which is formed as stated above, is calcined by performing a heat treatment thereon, thereby allowing the first electrode material and the second electrode material to be crystallized and allowing the highly-active layer to be formed by a solid phase reaction on the interface between the first electrode material layer and the second electrode material layer. An electrode material contained in the highly-active layer serves as the air electrode catalyst material according to the present embodiment. The atmosphere under which the heat treatment is performed is usually air; however, when an oxygen partial pressure is intended to be lowered, an inert gas, such as nitrogen (N₂), argon (Ar), helium (He), or the like may be used. In addition, when an amount of oxygen deficiency in the air electrode is intended to be increased aggressively, it is preferable that the heat treatment is performed in a reducing gas, such as diluted CO, or the like.

Under the temperature condition of the heat treatment, the temperature is usually raised from a temperature near to room temperature to a predetermined one at a certain temperature gradient, and after the predetermined temperature is maintained for a certain period of time, the temperature is gradually cooled to a temperature near to room temperature. The temperature gradient, while the temperature is being raised, is 1° C./min to 200° C./min, and preferably 5° C./min to 50° C./min. By making the temperature gradient to be 1° C./min or more, it can be avoided more surely that productivity may be deteriorated due to a drastic increase in the heat treatment time. On the other hand, by making the temperature gradient to be 200° C./min or less, a fear can be avoided more surely, in which a crack may be caused in the electrode or the electrolyte layer due to rapid thermal expansion.

The retention temperature during the calcining is 450° C. to 1200° C., and preferably 500° C. to 1000° C. By making the retention temperature to be 450° C. or higher, both the crystallization of the first electrode material layer and the second electrode material layer and the advance of the solid phase reaction on the interface can be performed more surely. On the other hand, by making the retention temperature to be 1200° C. or lower, it can be avoided more surely that: each of the first electrode material layer and the second electrode material layer may further undergo a phase transition from the original crystal structure; or an undesirable reaction, such as thermal decomposition, may concur due to excessive advance of the solid phase reaction on the interface.

The retention time in the calcining process is 5 minutes to 36 hours, preferably 10 minutes to 12 hours, and more preferably 30 minutes to 4 hours. By making the retention time to be 5 minutes or longer, both the crystallization of the first electrode material layer and the second electrode material layer and the advance of the solid phase reaction on the interface can be performed more surely. On the other hand, by making the retention time to be 36 hours or shorter, it can be avoided more surely that productivity may be deteriorated or an undesirable solid phase reaction may concur because the heat treatment is performed for a longer period of time.

### (Identification of Highly-Active Layer)

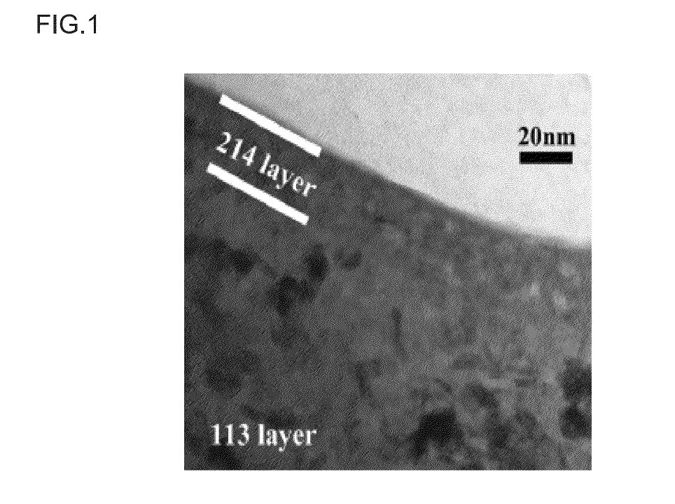

FIG. 1 is a transmission electron microscope (TEM) image of a section of the calcined laminated body obtained by calcining the laminated body made of the electrolyte layer/the first electrode material layer/the second electrode material layer. In the view, the “113 layer” represents a portion that was the first electrode material layer before the calcining, and the “214 layer” represents a portion that was the second electrode material layer before calcining.

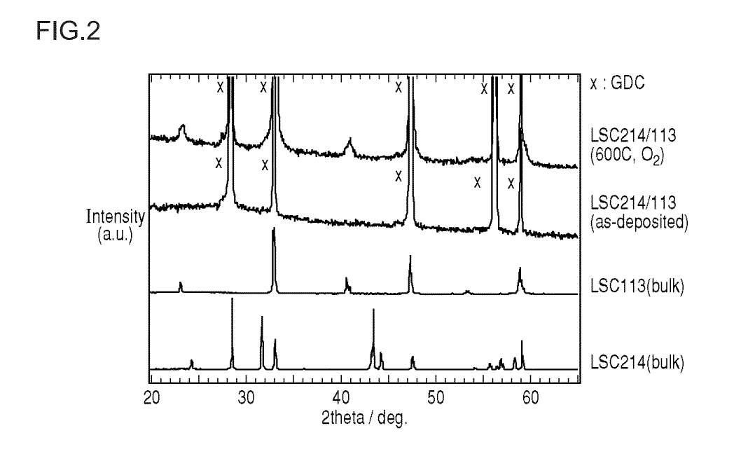

FIG. 2 is a graph showing XRD measurement results of the uncalcined (as deposited) laminated body and the calcined laminated body. In the view, XRD measurement results of a structure of the LSC 113 alone and a structure of the LSC 214 alone are also shown for comparison. In the view, the “LSC 214/113 (600° C., O₂)” represents measurement results of the calcined laminated body, the “LSC 214/113 (as-deposited)” represents measurement results of the uncalcined laminated body, the “LSC 113 (bulk)” represents measurement results of the structure of the LSC 113 alone, and the “LSC 214 (bulk)” represents measurement results of the structure of the LSC 214 alone.

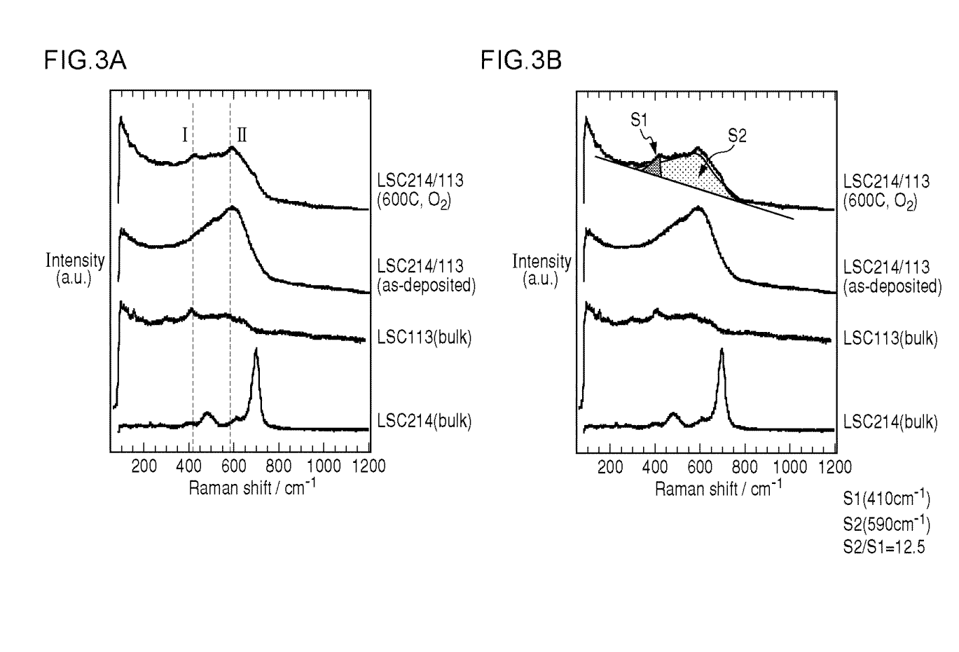

FIG. 3(A) is a graph showing Raman spectra measurement results of the uncalcined laminated body and the calcined laminated body. FIG. 3(B) is a graph showing results in which peak area ratios are calculated by fitting the Raman spectra measurement results of the uncalcined laminated body and the calcined laminated body with the use of a Gaussian function. In FIGS. 3(A) and 3(B), Raman spectra measurement results of the structure of the LSC 113 alone and the structure of the LSC 214 alone are also shown for comparison. In the views, the “LSC 214/113 (600° C., O₂) ” represents measurement results of the surface layer in the calcined laminated body, the “LSC 214/113 (as-deposited)” represents measurement results of the surface layer in the uncalcined laminated body, the “LSC 113 (bulk)” represents measurement results of the structure of the LSC 113 alone, and the “LSC 214 (bulk)” represents measurement results of the structure of the LSC 214 alone.

As shown in FIG. 1, in the calcined laminated body, a layer different from the first electrode material layer is formed to have a thickness equal to that of the second electrode material layer that was laminated on the first electrode material layer before the uncalcining. In addition, as shown in FIG. 2, a clear crystal lattice peak derived from the 113 structure is confirmed, but a crystal lattice peak derived from the 214 structure is not confirmed, with respect to the layer on the first electrode material layer in the calcined laminated body. From this, it can be considered that: the surface layer of the calcined laminated body, which was the second electrode material layer in the uncalcined laminated body, is close to the 214 phase in chemical composition; but the crystal structure thereof is different from that of the 214 structure. That is, the air electrode catalyst material according to the present embodiment shows a peak derived from the 113 phase in a chart obtained by an X-ray diffraction measurement. Herein, a crystal lattice peak is not confirmed with respect to the surface layer of the uncalcined laminated body, and hence it is suggested that the surface thereof is amorphous.

In addition, as shown in FIG. 3(A), an absorption peak I derived from the 113 structure was confirmed between 380 cm⁻¹ and 440 cm⁻¹, and further an absorption peak II, which is not seen with respect to the structure of the 113 alone, was confirmed between 560 cm⁻¹ and 620 cm⁻¹, as a result of Raman spectra analysis of the calcined laminated body. In addition, as shown in FIG. 3(B), a peak area S1 of the absorption peak I and a peak area S2 of the absorption peak II were calculated by fitting the measured Raman spectra with a Gaussian function and by using integration (area) of the separated peaks from the base line. Further, a peak area ratio S2/S1 was calculated by using the obtained peak areas S1 and S2. This peak area ratio S2/S1 is 1 or more, preferably 5 or more, and more preferably 10 or more. The peak area ratio in the present embodiment was 12.5. That is, in the air electrode catalyst material according to the embodiment, the absorption peak area between 560 cm⁻¹ and 620 cm⁻¹ (inclusive) is larger than that between 380 cm⁻¹ and 440 cm⁻¹ (inclusive) in Raman spectra.

From the Raman spectra measurement results, a conclusion is obtained, in which: the second electrode material layer (214 phase) formed on and adjacently to the first electrode material layer (113 phase) undergoes a solid phase reaction between the two layers after being subjected to a heat treatment; and a new crystal state, different from the intrinsic 214 phase and 113 phase, is formed. This layer is equivalent to the highly-active layer. The 214 phase before being calcined has a composition in which an amount of A sites in a perovskite (113) structure is excessive (an amount of B sites is relatively insufficient), in comparison with the 113 phase. Accordingly, it can be considered that the surface layer (highly-active layer) obtained after the solid phase reaction, i.e., the air electrode catalyst material according to the present embodiment has a composition in which B sites are deficient in the 113 structure.

### (Evaluation of Electrode Reaction)

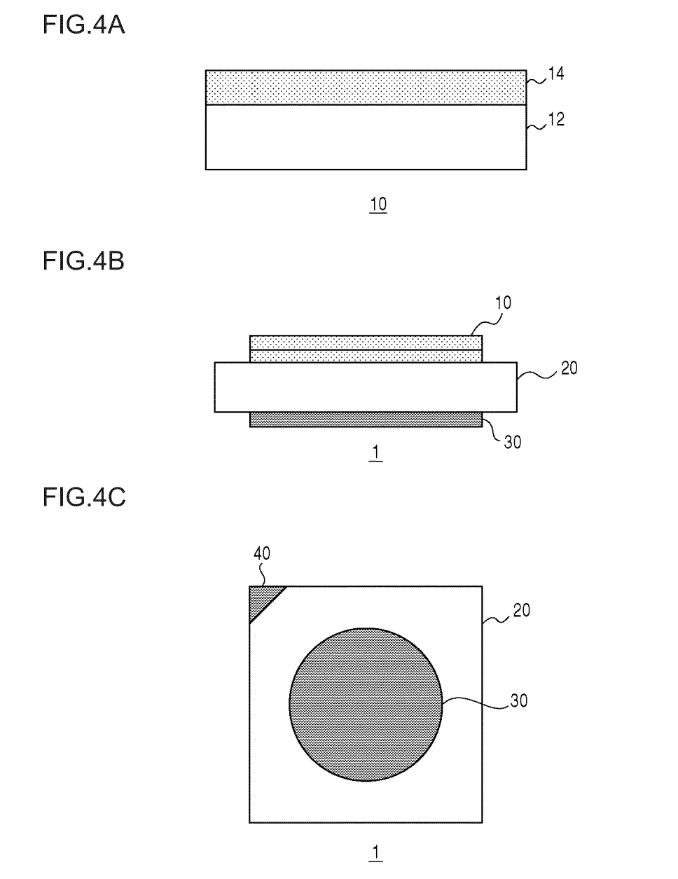

FIGS. 4(A) to 4(C) are schematic views illustrating a cell structure for evaluating the performance of the calcined laminated body containing the air electrode catalyst material according to the embodiment, when the laminated body is used as an air electrode. FIG. 4(A) is a sectional view of the calcined laminated body, FIG. 4(B) is a side view of a performance evaluation cell, and FIG. 4(C) is a plain view of the performance evaluation cell, viewed from the counter electrode side. As illustrated in FIGS. 4(A) to 4(C), a calcined laminated body 10 and an electrolyte body 20 were first provided. The calcined laminated body 10 has a first electrode material layer 12 and a highly-active layer 14 laminated on the first electrode material layer 12. The thickness of the highly-active layer 14 is 20 nm. The electrolyte body 20 is made of a GDC polycrystalline electrolyte layer.

The calcined laminated body 10 was laminated on one of the major surfaces of the electrolyte body 20 in order to make the calcined laminated body 10 serve as a working electrode (WE). A Pt electrode 30, as a counter electrode (CE), was formed on the other major surface of the electrolyte body 20 by performing Pt sputtering, the other major surface being opposite to the side where the calcined laminated body 10 was laminated. Further, an electrode 40, as a reference electrode (RE), was formed in part of the electrolyte body 20 by coating Pt paste. A performance evaluation cell 1 was obtained by the aforementioned steps. In the performance evaluation cell 1, the calcined laminated body 10 is equivalent to an air electrode. When a fuel electrode catalyst material is used instead of Pt, the counter electrode (CE) is equivalent to a fuel electrode.

An electrode reaction resistance Rpol, which was associated with an SOFC air electrode reaction, was measured: by applying an alternating electric field between the WE and the CE to measure a potential difference between the WE and the RE; and by an alternating current impedance method, and then the interface electrical conductivity σ_{E} was calculated from the inverse of the electrode reaction resistance. As the measurement conditions, a sample temperature was 400 to 600° C., and an oxygen partial pressure near to the air electrode was 1 atm. The impedance measurement was performed within a range of 10 kHz to 10 mHz.

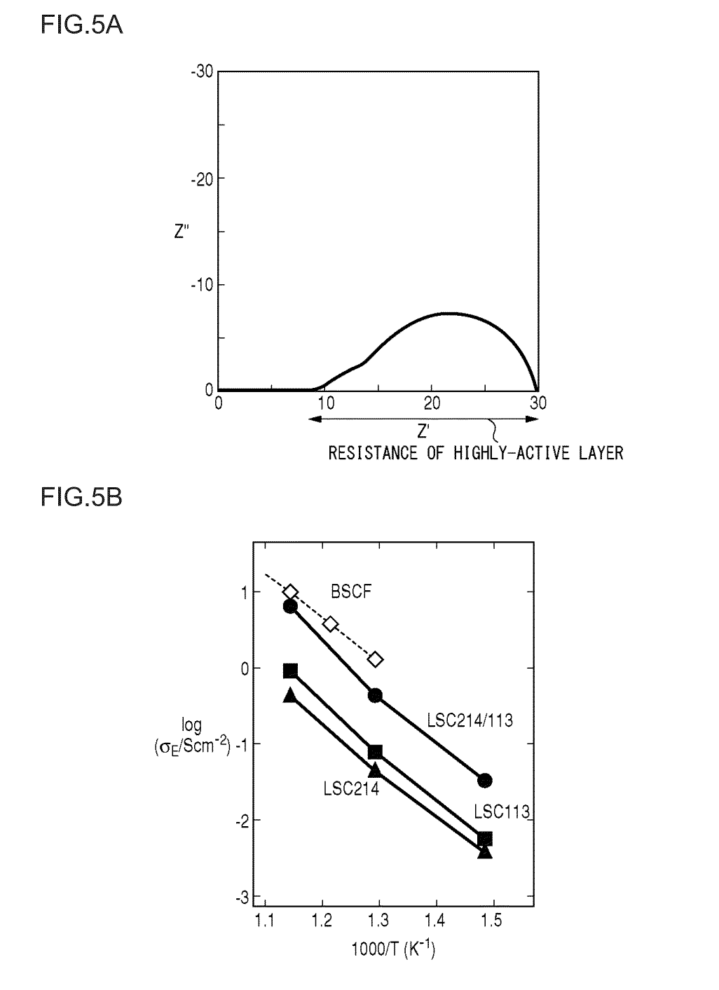

FIG. 5(A) is a graph (Nyquist plot) obtained by plotting, on a complex plane, the impedance values measured for the calcined laminated body, which was calcined at the sample temperature of 600° C. In FIG. 5(A), the horizontal axis Z′ represents the real part of an impedance Z that is a complex number, and the vertical axis Z″ represents the imaginary part thereof.

FIG. 5(B) is a graph showing temperature dependence of the electrical conductivity in the calcined laminated body. FIG. 5(B) also shows, for comparison, the temperature dependence of the electrical conductivity in each of the LSC 113 alone and the LSC 214 alone. In addition, FIG. 5(B) also shows, for reference, the temperature dependence of the electrical conductivity in a Ba—Sr—Co—Fe—O perovskite oxide. The horizontal axis represents temperature states [1000/T (K⁻¹)], and the vertical axis represents interface electrical conductivity states [log (σ_{E}/Scm⁻²)]. In FIG. 5(B), the “LSC 214/113” and the black circle plots represent the measurement results of the calcined laminated body, the “LSC 113” and the black square plots represent those of the LSC 113 alone, the “LSC 214” and the black triangle plots represent those of the LSC 214 alone, and the “BSCF” and the white square plots represent those of the Ba—Sr—Co—Fe—O perovskite oxide. In addition, with respect to each of the plots of the calcined laminated body, the LSC 113 alone, and the LSC 214 alone, the plots on the left side represent measurement results in which the sample temperature was 600° C., the plots at the center represent those in which the sample temperature was 500° C., and the plots on the right side represent those in which the sample temperature was 400° C.

As shown in FIGS. 5(A) and 5(B), the calcined laminated body had a high electrical conductivity. When compared at the same sample temperature, an improvement in the interface electrical conductivity σ_{E} of the calcined laminated body, which is larger than that of each of the 113 alone and the 214 alone by almost one order of magnitude, has been confirmed at each of the sample temperatures. Accordingly, it is known that the highly-active layer 14, and eventually the air electrode catalyst material according to the present embodiment has a high electrical conductivity at a low temperature.

As stated above, the air electrode catalyst material according to the present embodiment can be represented by the general formula (1), and contains a perovskite oxide having a ratio x/y of A to B of 1.05≦x/y≦1.5, in which a peak derived from the perovskite oxide A₁B₁O_{3-σ} is shown in a chart obtained by an X-ray diffraction measurement, and in which, in Raman spectra, an area of absorption peak existing between 560 cm⁻¹ and 620 cm⁻¹ (inclusive) is larger than that between 380 cm⁻¹ and 440 cm⁻¹ (inclusive). Thereby, the air electrode activity at a low temperature can be improved, and as a result of that, the operating temperature of an SOFC can be lowered. Accordingly, by using the air electrode catalyst material according to the present embodiment, and further by combining the catalyst material with a low-temperature ion conducting solid oxide electrolyte, an SOFC system capable of working at a temperature lower than before can be achieved.

A method of manufacturing the air electrode catalyst material according to the present embodiment comprises: arranging a first electrode material and a second electrode material so as to be adjacent to each other, the first electrode material being represented by the general formula (1), in which a ratio x/y of the A to the B is 0.80≦x/y≦1.25, and the second electrode material having a ratio x/y of the A to the B in the general formula (1) of 1.5≦x/y≦2.5; and calcining the first electrode material and the second electrode material, which are arranged so as to be adjacent to each other, at a temperature higher than or equal to 450° C. By performing a heat treatment on different crystal phases that are arranged so as to be adjacent to each other, as stated above, a highly-active layer having a new crystal form can be formed by an interface solid phase reaction, thereby allowing an air electrode, having an interface electrical conductivity derived from a high air electrode reaction even at a low temperature, to be formed. Further, the highly-active layer can be industrially manufactured with good reproducibility.

The invention according to the aforementioned embodiments may be specified as flows. That is, the present invention can be specified as a solid oxide fuel cell system comprising: an air electrode containing the air electrode catalyst material according to the present embodiment; a fuel electrode; and an electrolyte body arranged between the air electrode and the fuel electrode. In this case, the air electrode may have: the first electrode material layer 12 that contains a first electrode material having an element ratio x/y of A to B in the general formula (1) of 0.80≦x/y<1.25; and the highly-active layer 14 that contains the air electrode catalyst material according to the embodiment and that is laminated on the first electrode material layer 12.

The present invention should not be limited to the aforementioned embodiments, and various modifications, such as design modifications, can be made with respect to the above embodiments based on the knowledge of those skilled in the art, and an embodiment with such a modification can fall within the scope of the present invention.

For example, embodiments obtained by combing the following items can fall within the scope of the present invention.

### (Item 1)

An air electrode catalyst material to be used in solid oxide fuel cells, comprising: a perovskite oxide represented by a general formula (1): AₓB_{y}O_{3-δ} (wherein, A contains at least one element selected from the group consisting of Mg, Ca, Sr, Ba, Sc, Y, and lanthanoid element; B contains at least one element selected from the group consisting of Mn, Fe, Co, and Ni; and δ indicates an amount of oxygen deficiency or oxygen excess for matching the valence number of the perovskite oxide), in which a ratio x/y of the A to the B is 1.05≦x/y≦1.5, and in which a peak derived from a perovskite structure A₁B₁O₃₋₆ is shown in a chart obtained by an X-ray diffraction measurement, and in Raman spectra, an area of absorption peak existing between 560 cm⁻¹ and 620 cm⁻¹ (inclusive) is larger than that between 380 cm⁻¹ and 440 cm⁻¹ (inclusive).

### (Item 2)

The air electrode catalyst material according to Item 1, in which the perovskite oxide contains La as the A and Co as the B.

### (Item 3)

The air electrode catalyst material according to Item 2, in which the perovskite oxide has a structure represented by a general formula (2): La_{(1-z)x}Sr_{zx}Co_{y}O_{3-δ}.

### (Item 4)

The air electrode catalyst material according to Item 3, in which a substitution rate z at which La in the A has been substituted by Sr is 0.05≦z≦0.75.

### (Item 5)

A solid oxide full cell system comprising: an air electrode containing the air electrode catalyst material according to any one of Items 1 to 4; a fuel electrode; and an electrolyte body arranged between the air electrode and the fuel electrode.

### (Item 6)

The solid oxide fuel cell system according to Item 5, in which the air electrode has: a first electrode material layer containing a first electrode material having the ratio x/y in the general formula (1) of 0.80≦x/y<1.25; and a highly-active layer that contains the air electrode catalyst material and that is laminated on the first electrode material layer.

### (Item 7)

A method of manufacturing an air electrode catalyst material to be used in solid oxide fuel cells, comprising: arranging a first electrode material and a second electrode material so as to be adjacent to each other, the first electrode material being represented by a general formula (1): AₓB_{y}O_{3-δ} (wherein, A contains at least one element selected from the group consisting of Mg, Ca, Sr, Ba, Sc, Y, and lanthanoid element; B contains at least one element selected from the group consisting of Mn, Fe, Co, and Ni; and δ indicates an amount of oxygen deficiency or oxygen excess for matching the valence number of the perovskite oxide), in which a ratio x/y of the A to the B is 0.80≦x/y<1.25, and the second electrode material having a ratio x/y of the A to the B in the general formula (1) of 1.5≦x/y≦2.5; and calcining the first electrode material and the second electrode material, which are arranged so as to be adjacent to each other, at a temperature higher than or equal to 450° C.

### (Item 8)

The method of manufacturing an air electrode catalyst material according to Item 7, in which the arranging the first electrode material and the second electrode material so as to be adjacent to each other includes: forming a first electrode material layer; and forming a second electrode material layer on the first electrode material layer.

### (Item 9)

The method of manufacturing an air electrode catalyst material according to Item 8 comprising: forming the second electrode material layer by a pulse laser process, a sputtering process, or a chemical vapor deposition process.

### (Item 10)

The method of manufacturing an air electrode catalyst material according to any one of Items 7 to 9, in which the arranging the first electrode material and the second electrode material so as to be adjacent to each other includes: forming a first electrode material layer on an electrolyte body by a pulse laser process, a sputtering process, or a chemical vapor deposition process.

What is claimed is:

1. An air electrode catalyst material to be used in solid oxide fuel cells, comprising:
a perovskite oxide represented by a general formula (1): AₓB_{y}O_{3-δ} (wherein, A contains at least one element selected from the group consisting of Mg, Ca, Sr, Ba, Sc, Y, and lanthanoid element; B contains at least one element selected from the group consisting of Mn, Fe, Co, and Ni; and δ indicates an amount of oxygen deficiency or oxygen excess for matching the valence number of the perovskite oxide), wherein
a ratio x/y of the A to the B is 1.05≦x/y≦1.5, and wherein
a peak derived from a perovskite structure A₁B₁O_{3-δ} is shown in a chart obtained by an X-ray diffraction measurement, and in Raman spectra, an area of absorption peak existing between 560 cm⁻¹ and 620 cm⁻¹ (inclusive) is larger than that between 380 cm⁻¹ and 440 cm⁻¹ (inclusive).

2. The air electrode catalyst material according to claim 1, wherein
the perovskite oxide contains La as the A and Co as the B.

3. The air electrode catalyst material according to claim 2, wherein
the perovskite oxide has a structure represented by a general formula (2): La_{(1-z)x}Sr_{zx}Co_{y}O_{3-δ}.

4. The air electrode catalyst material according to claim 3, wherein
a substitution rate z at which La in the A has been substituted by Sr is 0.05≦z≦0.75.

5. A solid oxide full cell system comprising:
an air electrode containing the air electrode catalyst material according to claim 1;
a fuel electrode; and
an electrolyte body arranged between the air electrode and the fuel electrode.

6. The solid oxide fuel cell system according to claim 5, wherein
the air electrode has: a first electrode material layer containing a first electrode material having the ratio x/y in the general formula (1) of 0.80≦x/y<1.25; and a highly-active layer that contains the air electrode catalyst material and that is laminated on the first electrode material layer.

7. A method of manufacturing an air electrode catalyst material to be used in solid oxide fuel cells, comprising:
arranging a first electrode material and a second electrode material so as to be adjacent to each other, the first electrode material being represented by a general formula (1): AₓB_{y}O_{3-δ} (wherein, A contains at least one element selected from the group consisting of Mg, Ca, Sr, Ba, Sc, Y, and lanthanoid element; B contains at least one element selected from the group consisting of Mn, Fe, Co, and Ni; and δ indicates an amount of oxygen deficiency or oxygen excess for matching the valence number of the perovskite oxide), in which a ratio x/y of the A to the B is 0.80≦x/y<1.25, and the second electrode material having a ratio x/y of the A to the B in the general formula (1) of 1.5≦x/y≦2.5; and
calcining the first electrode material and the second electrode material, which are arranged so as to be adjacent to each other, at a temperature higher than or equal to 450° C.

8. The method of manufacturing an air electrode catalyst material according to claim 7, wherein
the arranging the first electrode material and the second electrode material so as to be adjacent to each other includes:
forming a first electrode material layer; and forming a second electrode material layer on the first electrode material layer.

9. The method of manufacturing an air electrode catalyst material according to claim 8 comprising:
forming the second electrode material layer by a pulse laser process, a sputtering process, or a chemical vapor deposition process.

10. The method of manufacturing an air electrode catalyst material according to claim 7, wherein
the arranging the first electrode material and the second electrode material so as to be adjacent to each other includes: forming a first electrode material layer on an electrolyte body by a pulse laser process, a sputtering process, or a chemical vapor deposition process.
